(19) United States
(12) Patent Application Publication
(10) Pub. No.: US 2008/0244567 A1
(43) Pub. Date: Oct. 2, 2008

(54) Portable printer driver

(75) Inventor: Xiaonong Zhan, Foster City, CA (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Konica Minolta Systems Laboratory, Inc.

(21) Appl. No.: 11/731,551

(22) Filed: Mar. 30, 2007

(51) Int. Cl. G06F 9/445

(52) U.S. Cl. 717/178

(57) ABSTRACT

In accordance with the devices, systems and methods described herein a portable printer driver may be automatically uploaded and installed by using a helper application when a portable drive or portable memory device is coupled to a host. The portable printer driver and helper application may be stored on the portable memory device. The helper application may be automatically loaded into host memory, where it subsequently resides, using plug and play capability available on the host. The helper application, which is capable of being host memory resident, can monitor the state of specified computer events. Specifically, the helper application can detect the removal of the portable memory device and delete any files associated with the printer driver from the host.

### BACKGROUND

1. Field of the Invention

The present invention relates to the field of portable printer drivers, specifically to drivers for portable printers stored on portable memory devices.

2. Description of Related Art

A printer driver may convert the data to be printed to the form specific for a given printer. One purpose of printer drivers is to enable applications, such as word processing applications, to have print capacity without having to address the technical details particular to a given printer model.

Conventionally, when a printer is plugged into a USB port, the host machine may detect and identify the newly attached device. If the attached peripheral device is a printer, the operating system (OS) may detect the printer, identify the printer, and look for a driver to communicate with the printer. Drivers are typically installed on the hard drive of the host, from files available to the operating system, or on a network-accessible hard drive, or on a portable memory device, such as a compact disc (CD), or an USB drive. A driver may be unique to a device or may be a generic driver used by the operating system. In addition, different operating systems may use different drivers for the same printer.

Today, printers and computers are both portable and extensively networked. There are a multitude of situations in which a user may desire to have a portable printer driver. For example, printer drivers' available on a user's computer may not include the driver for a particular printer. As another example, a portable printer, such as a personal portable photographic printer carried by a user may need a specific driver not easily available. In another situation, a printer may be a rarely used network printer for which a driver is not easily available or locatable from the user's computer. In a further situation, the available driver may not provide access to specialized printer features of interest to the user.

There may also computers and systems where a user may need to use a particular printer driver but may not be able to install the driver because of storage restrictions or memory limitations. For the situations described above, a user may wish to install a driver temporarily to permit printing to a printer of choice but with minimal alterations to host configuration. In addition, an automatic or simple procedure to install the driver would greatly facilitate use of the chosen printer.

Thus, there is a need for a printer driver, which is portable and easily and automatically removed from the host, such that files and/or other fixed indications of usage do not remain on the host.

### SUMMARY

In accordance with the present invention, devices, systems, and methods are presented, which provide a portable printer driver. A method of providing access to capabilities available on a printer coupled to a host computer using a portable memory device that holds a printer driver and a helper application capable of memory-resident execution on the host computer is described, wherein the method comprises: executing the memory-resident helper application on a host computer when the memory device is coupled to a port on the host computer. The helper application, which is memory resident on the host computer, invokes an installation procedure for the printer driver; updates a printer description file stored on the portable memory device with drive letter and path information; updates system information on the host computer with information related to the printer and the printer driver; and invokes an exit procedure that removes printer and driver related information on the host computer when the portable memory device is decoupled from the host computer.

These and other embodiments are further explained below with respect to the following figures.

### BRIEF DESCRIPTION OF THE DRAWINGS

FIG. 1 shows a block diagram of an exemplary system for printing including a potable printer and portable memory devices.

FIG. 2 shows a block diagram of an exemplary portable printer driver stored on a portable memory device.

FIG. 3 shows an exemplary flow chart describing steps in the installation of a portable printer driver.

FIG. 4 shows an exemplary flow chart describing steps in the removal of a portable memory device from the host.

### DETAILED DESCRIPTION

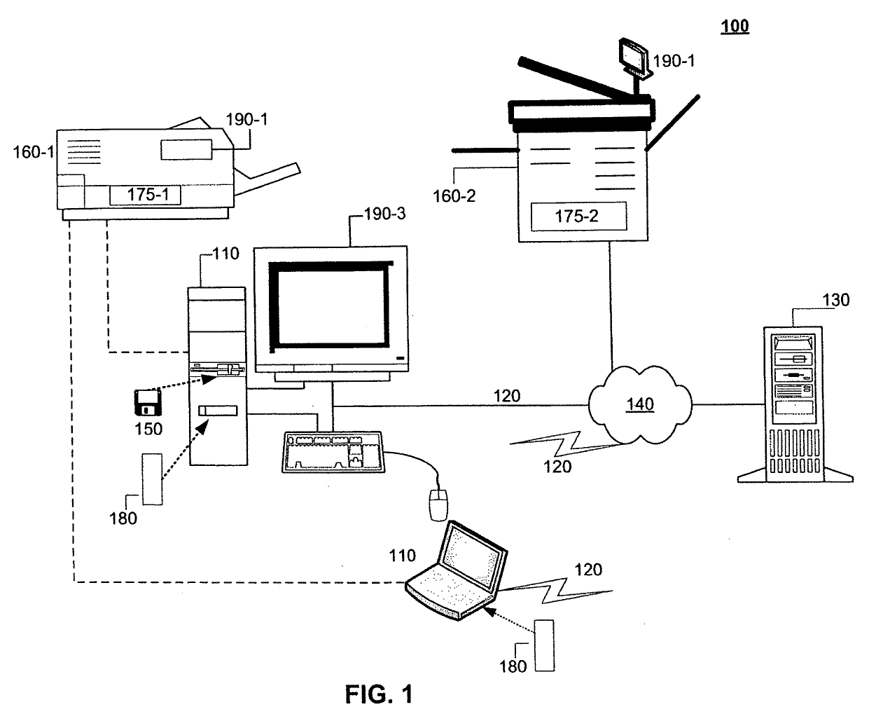

In accordance with the present invention, devices, systems, and methods for a portable printer driver are presented. FIG. 1 shows an exemplary block diagram of a printing system in which an exemplary embodiment of the present invention may be deployed. A computer software application consistent with the present invention may be deployed on one or more networked computers, or printers, as shown in FIG. 1, that are connected through communication links that allow information to be exchanged using conventional communication protocols and/or data port interfaces.

As shown in FIG. 1, exemplary system 100 includes a computer 110 and a server 130. Further, computer 110-1 and server 130 may communicate over a connection 120, which may pass through network 140, which in one case could be the Internet. Computer 110 may be a computer workstation, desktop computer, laptop computer, or any other computing device capable of being used in a networked environment. Computer 110 may play the role of a host computer to provide access to memory devices, and peripherals coupled to computer 110. Programs, applications, and other utilities may access and utilize portable memory device 180, printers 160, or other peripherals using a host computer 110 coupled to the various devices. For example, a user may use host computer 110 to access and utilize the capabilities of a coupled printer 160-1 using applications, programs, and/or printer driver 200 stored on coupled portable memory device 180. Server 130 may be a platform capable of connecting to computer 110 and other devices too (not shown). Computer 110 and server 120 may be capable of executing software (not shown) that allows the control and configuration of printing devices 160, such as exemplary printing devices 160-1 and 160-2. For example, printing device 160-1 may be a portable printer, while printer device 160-2 may be a desktop printer.

Computer 110 may contain a removable media drive 150. Removable media drive 150 may include, for example, 3.5 inch floppy drives, CD-ROM drives, DVD ROM drives, CD±RW or DVD±RW drives, USB flash drives, and/or any other removable media drives consistent with embodiments of the present invention. Portions of software applications may reside on removable media and be read and executed by computer 110 using removable media drive 150. In some embodiments, programs, applications, drivers, and/or results or reports generated by applications may also be stored on media accessed using removable media drive 150.

In some embodiments, a host computer 110 may also have ports and/or interfaces for the coupling of portable memory devices 180, such as flash drives, USB drives, media, or multi-media players with storage capacity, or other portable memory devices, as shown in FIG. 1. In some embodiments, removable media drive 150 may also provide interfaces for the coupling of portable memory device 180. In some embodiments, programs, applications, drivers, and/or results or reports generated by applications may also be stored on portable memory device 180 for access and/or execution by host computer 110.

Connection 120 couples computer 110, server.130, and printer 160-2 and may be implemented as a wired or wireless connection using conventional communication protocols and/or data port interfaces. In general, connection 120 can be any communication channel that allows transmission of data between the devices. In one embodiment, for example, the devices may be provided with conventional data ports, such as USB, SCSI, FIREWIRE, and/or BNC ports for transmission of data through the appropriate connection 120. The communication links could be wireless links or wired links or any combination that allows communication between computer 110, server 130, and printer 160-2.

Network 140 could include a Local Area Network (LAN), a Wide Area Network (WAN), or the Internet. In some embodiments consistent with the present invention, information sent over network 140 may be encrypted to ensure the security of the data being transmitted.

Exemplary printing device 160-2, may be a network printer, and can be connected to network 140 through connection 120. In some embodiments, a printing device, such as exemplary printing device 160-1, may be a portable printer and connected directly to computer 110 and/or server 120 and/or laptop computer 110. System 100 may include multiple printing devices and other peripherals (not shown), according to embodiments of the invention.

Printing devices 160 may be controlled by hardware, firmware, or software, or some combination thereof. Printing devices 160 may include one or more print controller boards 175, such as exemplary print controllers 175-1 and 175-2, which may control the operation of printing devices 160. Printing devices 160 may be controlled by firmware or software resident on memory devices in print controllers 175. In general, print controllers 175 may be internal or external print devices 160. In some embodiments, printing devices 160 may also be controlled in part by software running on computer 110 or server 120.

Printing devices, such as exemplary printing device 160-2, may also include consoles 190 such as consoles 190-1 and 190-2, or other interfaces to allow configuration options to be set and other messages to be displayed. In some embodiments, one or more configuration options may be set using a display or user-interface on a monitor for a computer coupled to printing devices 160. For example, user interfaces to set one or more configuration options on printing device 160-1 may be displayed on monitor 190-3, which is coupled to computer 110. A user interface to set configuration options on printer 160-2 may also be displayed on monitor 190-3, using software running on server 130.

In some embodiments, configuration parameters pertaining to printing device 160 may be user-configurable. For example, the print resolution, document sizes, color options, and other configuration parameters may be user-configurable. A user may also be able to specify input trays and the use of automatic document feeders to allow batch processing of documents. Users may also be able to log into a printing device 160 to perform administrative functions such as to enable software or firmware on printing device 160 to perform various functions.

In some embodiments, a driver for exemplary portable printer 160-1 or printer 160-2 may reside on a memory device 180 coupled to computer 110. Computer 110 may use functionality provided by printer driver resident on memory device 180 to utilize the functionality provided by printer 160.

A computer software application consistent with the present invention may be deployed on memory devices couple to any of the exemplary computers, or printers as shown in FIG. 1. For example, computer 110 could execute software resident on memory device 180 that may control and/or monitor the operation of printer 160-1. An independent application may also execute concurrently on printer 160-2 based on its configuration. In general, applications may execute in whole or in part on one or more computers, print controllers, or printers in the system. Computers 110-1, 110-2 may be laptop or desktop, and may be independent or connected to a network.

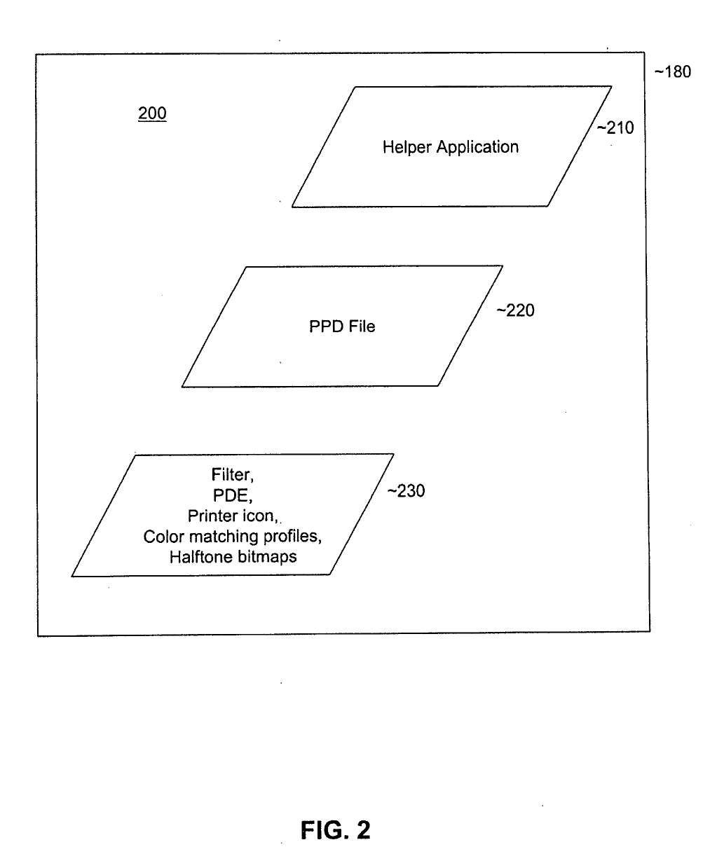

FIG. 2 shows a block diagram of an exemplary portable printer driver 200 stored on a portable memory device 180. Portable memory device 180 could be any of a USB drive, a flash drive, an MP3 player, a digital camera, or any other portable USB memory device capable of interfacing with computer 110. Modules of the portable printer driver 200 may include exemplary helper application 210, a printer description file such as a PostScript Printer Description (PPD) file 220, and printer driver files 230. The use of PPD files as printer description files is exemplary only. In some embodiments, printer description files may include files specified in Universal Printer Description Format (“UPDF”), or other well-known or widely accepted formats.

Helper application 210 may reside on portable memory device 180. When helper application is executed, it may remain memory resident on host computer 110 to which portable memory device 180 and printer 160 may be coupled. In some embodiments, helper application 210 may be resident in the main memory of host computer 110 and monitor specified events or state changes on host computer 110. Helper application 210 may include install and uninstall functions, and have the capacity to receive plug and play signals. For example, helper application 210 may receive a “plugged in” signal when portable memory device 180 is engaged in a USB port. Likewise, helper application 210 may be able to receive an unplug or eject notice, which may occur, for example, upon selecting a specified icon to commence disengagement of memory device 180 from the interface, such as a USB port.

PPD file 220 is a configuration file that may contain information about printer 160 and may specify printer properties. For example, PPD file 220 may be used by a PostScript driver to control printer 160. In some embodiments, PPD file 220 may be a text file that describes the features of a particular printer.

Variables such as paper sizes, number of input trays and duplexing options may be contained in PPD file 220, which may be used by PostScript driver to control printer 160. In some embodiments, customizable features may be configured using a printer dialog extension (PDE). For example, for Apple's Mac family of computers, PDEs may be used to set customizable options. Printer dialog extensions facilitate the provision of greater printer customization capabilities. Exemplary printer PPD file 220 may also contain a printer icon location, other printer configuration information, and the location of user interface printer dialog extension (PDE) files. In some embodiments, the PDE may be co-located with portions of printer driver files 230. In some embodiments, the PDE may also be located on a portable USB memory device 180. In some exemplary embodiments, PPD file 220 may be a generic PPD file that defines commonly available or standard features, such as standard letter sizes and other features generally available on most printers.

In some embodiments portable memory device 180 may contain printer driver files 230. In some embodiments, printer driver files 230 may remain on portable memory device 180. Printer driver files 230 may include filter files and color matching profiles. In some embodiments, files relating to PDEs, printer icons, and halftone bitmap files may also be included with printer driver files 230. Printer driver 200 may use some or all of printer driver files 230 in the generation of a print file, which may be used by printer 160 to print images, graphics, and/or text. In some embodiments, multiple filter files may be a part of printer driver files 230. Depending, in part on the type of data to be printed, image data may be processed through one filter, while other types of data may be processed through an alternate filter. Processed data can then be converted into PostScript data or into raster data. In some embodiments, additional filters may be applied to PostScript data so that more printer- or job-specific options can be added.

In one embodiment, printer 160 may be a graphical device interface (GDI) printer, which may include built-in capability to support a Microsoft Windows' graphical device interface. The Windows' application can use graphical device interface to display images on a monitor, so that when a user prints from a Windows' application to a GDI printer filtering and format conversion steps may be eliminated.

Printer driver 200 may convert an application program's printing request into a language for printer 160. In one embodiment, a PostScript printer driver may create a file that is accepted by PostScript printers. In another embodiment, a printer driver may create Printer Control Language (PCL) files. In some embodiments, a printer file in a format that is ready to be processed and printed by printer 160 may be created by printer driver 200.

In some embodiments, the Common UNIX Printing System (CUPS) may be used to provide a mechanism to allow print jobs to be sent to printers in a standard fashion. Application data may be sent to a scheduler for onward transmission to filters, which encode the data into print-readable form. The CUPS system permits utilization of PostScript and/or rasterization techniques to convert the data into a usable print format. CUPS is a standard printer manager system, which is modularized and able to process a multitude data formats on print server. CUPS can accommodate a wide number of printer makes and models, each using its own printer language(s) and format(s). In some embodiments, printer driver files may include files to support one or more of PDE, GDI, and/or CUPS.

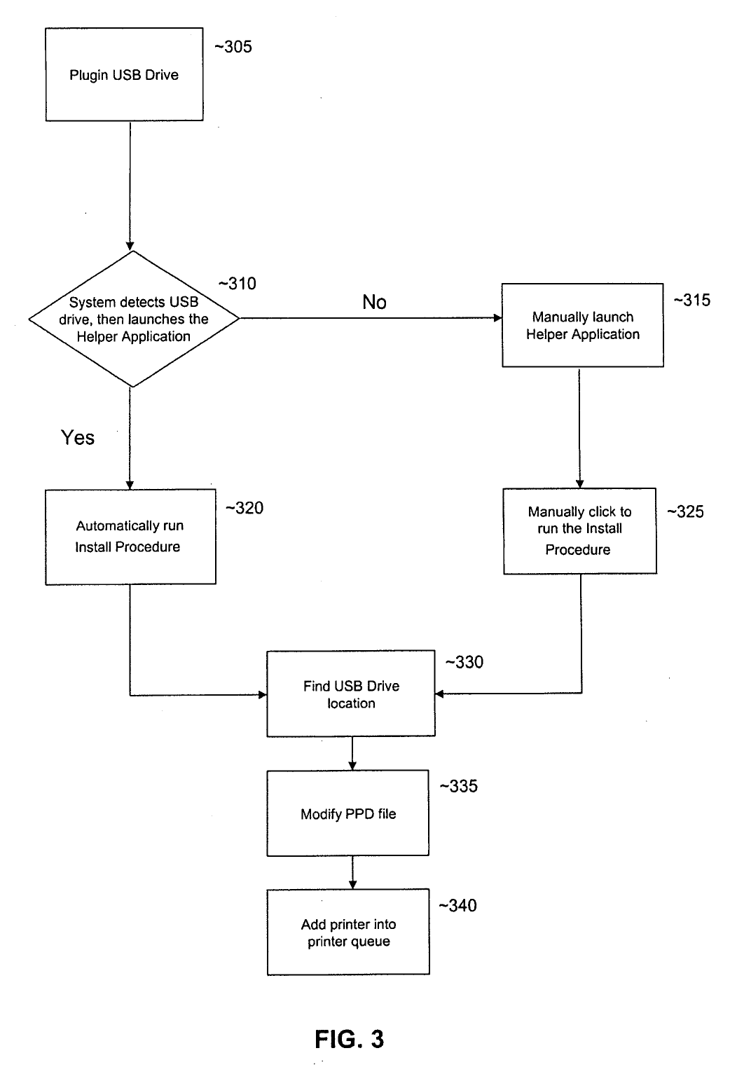

FIG. 3 shows an exemplary flow chart describing steps in the installation of a portable printer driver. In step 305 the plug-in, insertion, or coupling of portable memory device 180 to computer 110 is detected. In step 310, helper application 210 may be launched. In some embodiments, helper application 210 may use the plug and play capability of the operating system to facilitate communication between portable memory device 180 and computer 110 when the device is first connected to computer 110. For example, in Windows, the root directory of portable memory device 180 may contain a primary instruction file, “Autorun.inf”. Such a file may be a configuration file, which provides the operating system with information on executables to start icons to use, and menu commands to make available. By adding an entry for helper application 210 to a start file, such as the Autorun.inf file in Windows, the operating system on computer 110 can automatically run an installation executable for portable printer driver 200 when portable memory device 180 is detected. When helper application is executed, it may remain memory resident on host computer 110 to which portable memory device 180 and printer 160 may be coupled. In some embodiments, helper application 210 may be resident in the main memory of host computer 110 and monitor specified events or state changes on host computer 110.

If helper application 210 does not automatically launch, then a manual launch of the helper application 210 may be performed in step 315. In some embodiments, manual launching of helper application 210 may comprise responding to a dialogue box to run an install procedure. In some embodiments, helper application 210 will stay memory-resident even after memory device 180 is unplugged until it has completed the execution of specified tasks.

In step 320, the install procedure is automatically executed following the execution of helper application 210. In some embodiments, helper application 210 may invoke the install procedure. In step 320, helper application 210 may include a user interface, which may provide a dialog box, menu item, or icon to run the install procedure, if the install procedure does not activate automatically. In one embodiment, the install procedure may include copying path information for helper application 210 to an appropriate system location or registry entry on a host machine and running helper application 210 and printer driver 200 using the provided path information. In step 330, the drive letter assigned to portable memory device 180 may be derived and PPD file 220 may be modified to include or add the corresponding letter drive to path information. In step 340, the printer 160 may be added into an appropriate printer queue.

In some embodiments, no files are manually copied to the host hard drive when using portable printer driver 200. However, certain details of the portable driver may be written into main memory or RAM. In some embodiments, some files may be copied to the hard drive of host computer 110. For example, for CUPS, a PPD file may be copied to the hard drive of host computer 110 and located in an appropriate folder. When portable memory device 180 is unplugged, those files will be erased from the hard drive of host computer 110. The full path and filename of the drivers may also be written into one or more RAM locations.

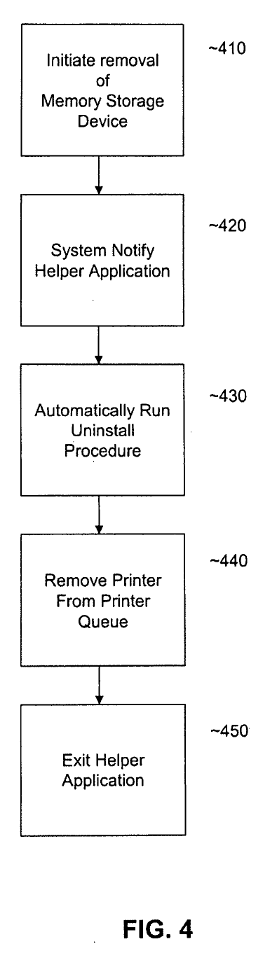

FIG. 4 shows an exemplary flow chart describing steps in the removal of a portable memory device 180 from the host. In step 410, portable memory device 180 may be removed from the host. Removing portable memory device 180 may include clicking on an eject icon, unplugging a USB drive, unplugging a USB device, or dragging an icon for a device to an ejection indicator.

In step 420, the host's operating system may generate a signal for impending ejection of portable memory device 180, which holds printer driver 200. In some embodiments, the signal may be received by memory-resident helper application 210. Upon receipt of the ejection notification, the helper application 210 may automatically run exemplary uninstall procedure in step 430.

In step 440, printer 160 may be removed from the printer queue. Next, in step 450, helper application 210 may exit. In some embodiments, helper application 210 may clean-up prior to exit to ensure that no files or indications of usage remain on computer 110. In some embodiments, the uninstall procedure and removal of portable memory device 180 from computer 110 may be performed while computer 110 is running and may not require shut down or restarting computer 110. In some embodiments, computer 110 may continue normal execution both before and after insertion and removal of portable memory device 180. Computer 110 may also continue normal execution during the operation of helper application 210; the install procedure; and the invocation of portable driver 200. The entire procedure starting from the connection of portable memory device 180 until its removal and the exit of helper application 210 may be transparent to any user of computer 110 except for the availability of portable printing device 160-1 during some intervening period.

Further, methods consistent with embodiments of the invention may conveniently be implemented using program modules and hardware modules. Such modules, when executed, may perform the steps and features disclosed herein, including those disclosed with reference to the exemplary flow charts shown in the figures. The operations, stages, and procedures described above and illustrated in the accompanying drawings are sufficiently disclosed to permit one of ordinary skill in the art to practice the invention. Moreover, there are many computers, operating systems, and printers that may be used in practicing embodiments of the instant invention.

The above-noted features and aspects of the present invention may be implemented in various environments. Such environments and related applications may be specially constructed for performing the various processes and operations of the invention, or they may include a general-purpose computer or computing platform selectively activated or reconfigured by program code to provide the functionality. The processes disclosed herein are not inherently related to any particular computer, printing apparatus, or storage media and aspects of these processes may be implemented by any suitable combination of hardware, software, and/or firmware

Embodiments of the present invention also relate to portable computer-readable media that include program instructions or program code for performing various computer-implemented operations based on the methods and processes of embodiments of the invention. Examples of program instructions include, for example, machine code, such as produced by a compiler, and files containing a high-level code that can be executed by the computer using an interpreter.

Other embodiments of the invention will be apparent to those skilled in the art from consideration of the specification and practice of the embodiments of the invention disclosed herein. It is intended that the specification and examples be considered as exemplary only, with a true scope and spirit of the invention being indicated by the following claims. As such, the invention is limited only by the following claims.

1. A method of providing access to capabilities available on a printer coupled to a host computer using a portable memory device that holds a printer driver and a helper application capable of memory-resident execution on the host computer, the method comprising:
executing the memory-resident helper application on the host computer when the portable memory device is coupled to an interface on the host computer, wherein the helper application:
invokes an installation procedure for the printer driver;
updates a printer description file stored on the portable memory device with drive letter and path information;
updates system information on the host computer with information related to the printer and the printer driver; and
invokes an exit procedure that removes printer and printer driver related information on the host computer when the portable memory device is decoupled from the host computer.

2. The method of claim 1, wherein updating a printer description file on the portable memory device with drive letter and path information further comprises:
querying the host computer for a drive letter assigned to the portable memory device; and
updating a path names in the printer description file with the drive letter information received in response to the query.

3. The method of claim 1, wherein the method is performed without permanently copying files from the portable memory device to fixed storage on the host computer.

4. The method of claim 1, wherein the helper application executes automatically when the portable memory device is coupled to the host computer.

5. The method of claim 4, wherein the helper application executes automatically using plug and play functionality available on the host computer.

6. The method of claim 1, wherein the printer description file is a postscript printer description file.

7. The method of claim 1, wherein the printer description file is a universal printer description format file.

8. The method of claim 1, wherein the portable memory device is one of:
a memory stick;
a flash memory drive;
a media player;
a handheld computing device; or
a hard drive.

9. The method of claim 1, wherein updating system information on the host computer comprises one or more of:
updating the system registry to indicate the location of the driver;
updating system memory locations with driver related information;
updating the list of available printers on the system; and
enqueueing the printer.

10. The method of claim 1, wherein the installation procedure for the print driver may utilize command and data files co-located with printer driver files to allow customization of printer capabilities.

11. The method of claim 1, wherein the driver installation procedure uses a generic printer description file.

12. The method of claim 1, wherein the host computer utilizes an operating system comprising one of Unix, Linux, or Windows.

13. A portable memory device that holds a printer driver and a helper application capable of memory-resident execution on a host computer, wherein the host computer is coupled to a printer, and the portable memory device contains instructions, which when executed by the host computer perform steps in a method for providing access to capabilities available on the printer, the steps comprising:
executing the memory-resident helper application on the host computer when the portable memory device is coupled to an interface on the host computer, wherein the helper application:
invokes an installation procedure for the printer driver;
updates a printer description file stored on the portable memory device with drive letter and path information;
updates system information on the host computer with information related to the printer and the printer driver; and
invokes an exit procedure that removes printer and printer driver related information on the host computer when the portable memory device is decoupled from the host computer.

14. The portable memory device of claim 13, wherein updating a printer description file with drive letter and path information further comprises:
querying the host computer for a drive letter assigned to the portable memory device; and
updating a path names in the printer description file with the drive letter information received in response to the query.

15. The portable memory device of claim 13, wherein the helper application performs operations without copying files permanently from the portable memory device to fixed storage on the host computer.

16. The portable memory device of claim 13, wherein the helper application automatically executes when the portable memory device is coupled to the host computer.

17. The portable memory device of claim 16, wherein the helper application automatically executes by using plug and play functionality provided by an operating system running on host computer.

18. The portable memory device of claim 13, wherein the printer description file is a postscript printer description file.

19. The portable memory device of claim 13, wherein the printer description file is a universal printer description format file.

20. The portable memory device of claim 13, wherein the portable memory device is one of:
a memory stick;
a flash memory drive;
a media player;
a handheld computing device; or
a hard drive.
